(19) United States
(12) Patent Application Publication
(10) Pub. No.: US 2012/0265667 A1
(43) Pub. Date: Oct. 18, 2012

(54) FINANCIAL INSTRUMENT DISCOVERY, TRANSPARENCY, COMMUNICATION, AND TRADING FACILITATION

(76) Inventors: Thomas Sachson, Menlo Park, CA (US); Hieu Tran, San Jose, CA (US)

(21) Appl. No.: 13/449,310

(22) Filed: Apr. 17, 2012

Related U.S. Application Data
(60) Provisional application No. 61/476,350, filed on Apr. 18, 2011.
(60) Provisional application No. 61/558,028, filed on Nov. 10, 2011.

(51) Int. Cl. G06Q 40/04

(52) U.S. Cl. 705/37

(57) ABSTRACT

The Financial Instrument Discovery, Transparency, Communication, and Trading Facilitation invention allows parties to virtualize prospective and existing financial instruments (including derivative and other analogous complex financial instruments) into one or more computer software applications via a user authoring software toolkit, and to upload such one or more virtualized instrument to a cloud hosting environment (or analogous online storage ecosystem) for further sharing of such virtualized instruments with interested parties over a communications network where other market participants may engage with the cloud hosting environment and search for, download, and review such virtualized instruments. Further, the Invention allows for downloading parties and authors to communicate directly and to do such “peer to peer” communications on an anonymous, partially anonymous, or non-anonymous basis, and have such communications be secure and/or encrypted.

### CROSS-REFERENCE

This application claims the benefit of U.S. Provisional Applications Nos. 61/476,350, by Sachson, entitled Derivative Contract Trading Facilitation Platform, filed on Apr. 18, 2011 and 61/558,028, by Sachson, entitled Derivative Contract Trading Facilitation Platform, filed on Nov. 10, 2011, the disclosures of which applications are incorporated herein by reference.

### BACKGROUND OF THE INVENTION

The current size and complexity of the over the counter (OTC) financial instrument market (including the derivatives market and other analogous markets for complex and non-standardized financial instruments) mandates the need for improved financial instrument discovery, financial market participant discovery, financial instrument price transparency, market participant communications, and market clearing and settlement capabilities amongst participants. However, the traditional methods for facilitating such activities (a centralized exchange, registry, clearinghouse, etc.) are ill suited to accomplishing this task due to concerns about costs, accessibility, and security.

As such, a new Financial Instrument Discovery, Transparency, Communication, and Trading Facilitation system and method (the current “Invention”) is needed to accomplish to following objectives:

(1) Provide and/or facilitate greater ease of financial instrument (e.g., derivative instrument) market participants (e.g., counterparties) to find (e.g., discover) other complementary market participants with which to do business;

(2) Provide and/or facilitate greater ease of financial instrument market participants to securely communicate (e.g., with bilateral anonymity, unilateral anonymity, or no anonymity) on a “peer to peer” basis with other market participants;

(3) Provide and/or facilitate greater ease of financial instrument market participants to assess the nature (e.g., characteristics and credibility) of other market participants prior to communicating and/or otherwise engaging with such other market participants;

(4) Provide and/or facilitate greater ease of financial instrument (e.g., derivative instrument) market participants (e.g., counterparties) to find (e.g., discover) numerous new, existing, or prospective financial instruments within the broader financial markets;

(5) Provide and/or facilitate greater ease of financial instrument market participants to enter new and existing financial instrument markets;

(6) Provide and/or facilitate improved pricing transparency of financial instruments;

(7) Provide and/or facilitate improved trading liquidity relating to financial instruments;

(8) Provide and/or facilitate improved pricing of financial instruments;

(9) Provide and/or facilitate improved record keeping and storage of data relating to financial instruments (including requisite backup and disaster recovery apparatus as needed);

(10) Provide and/or facilitate improved market abilities for determining the size and characteristics of financial instrument markets by all market participants (including but limited to counterparties, regulators, academics, the media, and any other party having a direct or indirect interest in the operation of financial instruments markets); and

(11) Providing a secure, customizable, low-cost, and easy to use alternative to market participants wishing to engage in the discovery of, review of, creation of, communication pertaining to, negotiation of, and/or sale or exchange of financial instruments without being forced to use and/or pay for a more expensive, less flexible, and more formalized listing mechanisms such as those represented by traditional centralized clearinghouses, exchanges, and registries.

Moreover, the aforementioned objectives must be accomplished in a manner that is easily understood by the financial instrument markets, regulators, the media, and others concerned with the efficient operation of financial instrument markets, with minimal costs (e.g. ideally little or no costs to the participants until a transaction or value added action is effected), is secure, scalable, and inclusive to all suitable and appropriate participants.

In light of these goals and requirements, the enclosed Financial Instrument Discovery, Transparency, Communication, and Trading Facilitation platform (the current “Invention”) has been created and is composed of unique and novel technology elements configured so as to create an effective system and method that is a marked improvement over the current art.

By enabling these improvements the subject invention solves the shortcomings of the prior art by creating a new mechanism by which people can search out and make meaningful new social connections relating to the financial markets in which they operate and do so efficiently and securely via the Internet.

### SUMMARY

The subject invention relates generally to user-generated content sharing systems and associated methods of operation and relates to a self-publishing, social networking system that is accessible by a plurality of entities over a network such as the Internet and engages in the creation, storing, searching, access, interaction, and communication relating to user-generated financial instrument data.

Specifically, the Financial Instrument Discovery, Transparency, Communication, and Trading Facilitation platform (the “Invention”) allows individuals wishing to create, record, and publish data pertianing to prospective and existing financial instruments to do so in a low-cost, secure, and efficient manner, and further facilitiates the discovery and review of such memorialized financial instruments by third parties and to further facilitate the communication between the creators or such memorialized financial instruments and the parties that discover such, and do so in a manner that is well-suited to a global Internet user base that desires to use social networking techniques as it engages in these types of activities.

Further, the method and apparatus pertaining to this invention may comprise a tangible machine readable medium storing instructions that, when executed by a computing device, cause the computing device to perform a method, which may comprise creating one or more data sets accessible by a plurality of entities over a network such as the Internet and engage in the creation, storing, searching, accessing, interacting, and communication relating to user-generated financial instrument data.

The system and method may be implemented on a computing device utilizing instructions from a tangible machine readable medium.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features, aspects and advantages of the disclosed and claimed subject matter of the present application are set forth with particularity in the appended claims. A better understanding of the aspects, features, and advantages of the disclosed and claimed subject matter will be obtained by reference to the following detailed description that sets forth what are meant to be only illustrative embodiments and not limiting disclosures, in which the principles of the Invention are utilized, and the accompanying drawings of which:

FIG. 1 illustrates a block diagram of the initial elements of the Invention where a System Administrator maintains a Networked Computer System and Database that produces a Parent Software Generator (e.g., an “application development kit”, “ADK” or “toolkit”) that is electronically delivered to an application authoring party (the Parent Software Generator User) who uses the Parent Software Generator to create another software application (e.g., a Child Software Application, being an application that is native or otherwise) representing a prospective or existing financial instrument and delivers such resulting financial instrument application (the created “child” application or Child Software Application) to an Online Storage Facility resident within the cloud and maintained by the System Administrator;

FIG. 2 illustrates a block diagram of the next elements of the Invention where the Child Software Application (the financial instrument application) resides in the cloud-based Online Storage Facility with other similarly situated Child Software Applications, and may be searched for and downloaded by a Child Software Application Downloading Party and when downloaded to the Child Software Application Downloading Party's remote location (e.g., their PC, tablet, phone) can be stored, reviewed, and interacted with by the Child Software Application Downloading Party. Further, as shown in this FIG. 2 block diagram, the Child Software Application may be capable of being opened and engaged with by a Child Software Application Downloading Party on a stand-alone application basis or with the support and assistance of a separate software application such as Child Software Application Reader or with the support and assistance of the Parent Software Generator that may also have an ability to open, read, and support the Child Software Application Downloading Party's engagements with any one or more Child Software Applications resident on their remote location;

FIG. 3 illustrates a block diagram of the next elements of the Invention where the Child Software Application resides within the Child Software Application Downloading Party's remote location and such application (perhaps in conjunction with the Child Software Application Reader that enables the functionality of Child Software Application) communicates (paths illustrated) with the System Administrator's Message Server for purposes of connecting the Software Application Downloading Party with the Parent Software Generator User that created that particular Child Software Application and further facilitating further message flow between the Child Software Application Downloading Party and the Parent Software Generator User via various paths illustrated;

FIG. 4 illustrates a block diagram of the communication elements of the Invention where the Child Software Application communicates a message to the Parent Software Generator User (pursuant to instructions provided to it by the user of the Child Software Application) via the System Administrator's Message Server which communicates with the Parent Software Generator User (utilizing his own Parent Software Generator as a messaging device) that created that particular Child Software Application, as well as showing scenarios where the user of the Child Software Application communicates with the assistance of either a Parent Software Generator or a Child Software Application Reader, as well as the use of secure User Identification Code Databases and User Addressing Databases for protecting the identities of the Invention's users as they communicate anonymously or non-anonymously via the System Administrator's Message Server;

FIG. 5 illustrates a block diagram of the communication elements of the Invention where the Child Software Application receives a communication from a Parent Software Generator (pursuant to instructions provided to it by the Parent Software Generator User) via the System Administrator's Message Server which receives such communication from the Parent Software Generator User (utilizing his own Parent Software Generator as a messaging device) that created that particular Child Software Application, as well as showing scenarios where the user of the Child Software Application communicates with the assistance of either a Parent Software Generator or a Child Software Application Reader, as well as the use of secure User Identification Code Databases and User Addressing Databases for protecting the identities of the Invention's users as they communicate anonymously or non-anonymously via the System Administrator's Message Server;

FIG. 6 illustrates a block diagram of the communication elements of the Invention illustrating the communication paths that are encrypted as the user of the Child Software Application communicates via the System Administrator's Message Server with the Parent Software Generator User that created that particular Child Software Application, as well as the various permutations of software elements (Parent Software Generator and the Child Software Application) that can be used to facilitate such communications within the Invention;

FIG. 7 illustrates a block diagram of the communication elements of the Invention illustrating the communication paths that are encrypted as the user of the Child Software Application communicates via the System Administrator's Message Server with the Parent Software Generator User that created that particular Child Software Application, as well as the various permutations of software elements (Child Software Application Reader, Parent Software Generator, and the Child Software Application) that can be used to facilitate such communications within the Invention;

FIG. 8 illustrates a block diagram of two current mechanisms for the promotion of financial instrument trading within the markets, namely the ad hoc, partially automated peer-to-peer over the counter trading model and the electronically automated centrally cleared and settled exchange model; and

FIG. 9 illustrates a block diagram of the current Invention showing itself to be a new technology embodiment combining the (i) peer-to-peer elements of the over the counter method with (ii) the electronically automated aspects of the exchange method, where the counterparties can instead engage in peer-to-peer over the counter financial instrument interactions utilizing the Invention's novel electronically enabled financial instrument creation, publication, discovery and communication system.

### DETAILED DESCRIPTION

Aspects, features and advantages of the disclosed and claimed subject matter can be seen in the description herein of a user-generated financial instrument content creation, storage, search, and sharing system, also referred to as the Financial Instrument Discovery, Transparency, Communication, and Trading Facilitation Invention.

In the Invention's most basic embodiment, the System Administrator 1 creates and distributes (via a web-based online home page, portal, hosting environment, or storefront) one or more application development toolkits (each toolkit a “Parent Software Generator 3”) to one or more market participants (each one a “Parent Software Generator User 4” who wish to use the Parent Software Generator 3 to create unique Child Software Applications 5 that represent actual or prospective financial instruments owned by, created by, being sold by, being purchased by, and/or associated with the Parent Software Generator User 4 where such Child Software Applications 5 are then uploaded by the Parent Software Generator User 4 to an Online Storage Facility 6 operated by or in conjunction with the System Administrator 1 so as to be searchable and downloadable by third parties (each one a “Child Software Application Downloading Party 7”) who are interested in downloading, reviewing, and/or interacting with the Child Software Application 5.

Once downloaded by the Child Software Application Downloading Party 7, the Child Software Application 5 can be used to send messages (and at various times either encrypted or not-encrypted, and either anonymous or non-anonymous) to and from the Child Software Application Downloading Party 7 and the Parent Software Generator User 4 for the purposes of facilitating the financial market's need for improved financial instrument discovery, financial instrument participant discovery, financial instrument price transparency, financial instrument market participant communication capability, financial instrument market clearing and settlement capabilities amongst participants, financial instrument regulatory insight, and other analogous financial instrument market requirements.

Specifically, the Invention contemplates that each Parent Software Generator 3 provided by the System Administrator 1 is assigned by the system its own unique Parent Software Generator Identification Code 18 where that identification code is incorporated into that distinct Parent Software Generator 3. Similarly, the system assigns each user of a particular Parent Software Generator 3 (the Parent Software Generator User 4) their own unique Parent Software Generator User Identification Code 26 at the time the prospective Parent Software Generator User 4 registers with the system. These two codes, used together or independently can enable the system to track which parties and toolkits are authoring what Child Software Applications 5 (representing distinct prospective or existing financial instruments) at any given time and location.

In terms of the Child Software Applications 5 generated, the Invention enables a Parent Software Generator User 4 to create any number of applications (either native applications or otherwise) that are virtualized versions of various financial instruments (e.g., usually, but not limited to, complex, illiquid financial contracts, such as derivative contracts) owned by, created by, being sold by, being purchased by, and/or associated with the Parent Software Generator User 4. Once a Child Software Application 5 is created by the Parent Software Generator 3 (incorporating unique data sets into the Child Software Application 5 itself from Parent Software Generator User 4 inputting the same into Parent Software Generator 3), the Invention or the Parent Software Generator 3 is capable of assigning a unique Child Software Application Identity Code 17 to that particular application representing the financial instrument and uploading the newly created Child Software Application 5 into an Online Storage Facility 6 (such as a portal, hosting environment, store, or analogous web-based repository for these applications) that is operated by the System Administrator 1. Once uploaded and stored within the Online Storage Facility 6, the Child Software Application 5 is accessible by any party that has registered (each one a “Application Seeking Registrant”, who may also become a Child Software Application Downloading Party 7 if they also proceed to download a Child Software Application 5 from the Online Storage Facility 6) with the System Administrator 1 for access to the system's Online Storage Facility 6 (e.g., hosting environment). Application Seeking Registrants to the system may engage with the stored Child Software Applications 5 in several ways, including through the use of a Child Software Application Reader 8 as provided by the system to the Application Seeking Registrant (or the Child Software Application Downloading Party 7 as the case may be), or through a similar function embedded within the Parent Software Generator 3 if previously made available to the Application Seeking Registrant, or through a traditional web browser with appropriate Child Software Application 5 permission elements pre-installed and enabled. In each case, the Application Seeking Registrant will be capable of any one or more of searching the Online Storage Facility 6, downloading Child Software Applications 5 from the Online Storage Facility 6, reviewing the same directly through the Child Software Application 5 itself as it is opened, or from within the Child Software Application Reader 8 (or enabled Parent Software Generator 3 or browser as the case may be), and thereafter engaging in message delivery between itself as the Child Software Application Downloading Party 7 to a Parent Software Application User 4.

The invention contemplates that the system may further assign each Application Seeking Registrant a Child Software Application Downloading Party Identification Code and/or an Application Seeking Registrant Identification Code if doing so will facilitate the functioning of the Invention, or in the alternative the Invention may not assign such a code to a Application Seeking Registrant until such time as the System Administrator 1 needs to track the activities of the Application Seeking Registrant more closely to effect the more advanced features of the Invention (e.g., sending messages will require the creation of a Child Software Application Downloading Party Identification Code, but the mere searching for, downloading of, and review of Child Software Applications 5 may not require the assignment to the Application Seeking Registrant of either a Child Software Application Downloading Party Identification Code or an Application Seeking Registrant Identification Code).

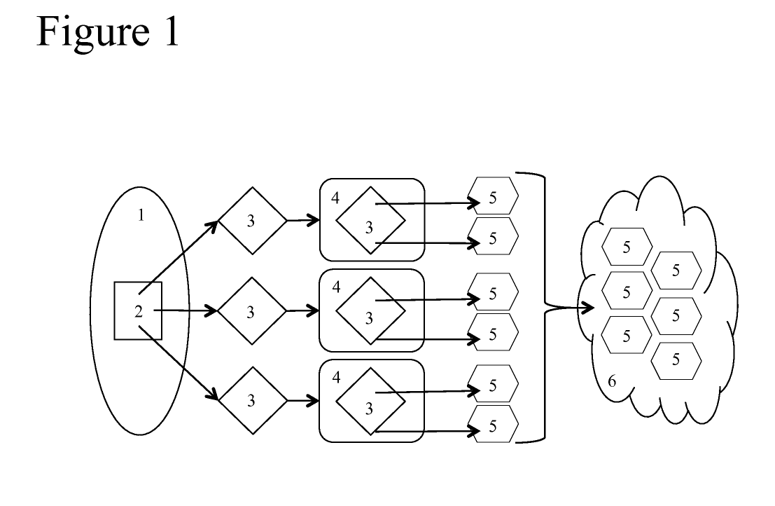

By way of example, FIG. 1 sets forth a block diagram where the System Administrator 1 manages a Networked Computer System and Database 2 that delivers a Parent Software Generator 3 to a party seeking to be a Parent Software Generator User 4 (upon request of the Parent Software Generator User 4). Thereafter, the Parent Software Generator User 4 uses Parent Software Generator 3 to create a Child Software Application 5 that is a virtualized version of a prospective or existing financial instrument associated with the Parent Software Generator User 4 (memorializing some or all of the terms of the financial instrument). Once generated, the Parent Software Generator User 4 instructs the Parent Software Generator 3 to upload the Child Software Applications 5 to an Online Storage Facility 6 administered by the System Administrator 1. This Online Storage Facility 6 (e.g., hosting environment, portal, store, web page, or analogous) then serves as a repository for numerous Child Software Applications 5 created by numerous Parent Software Generators 3 propagated throughout the markets.

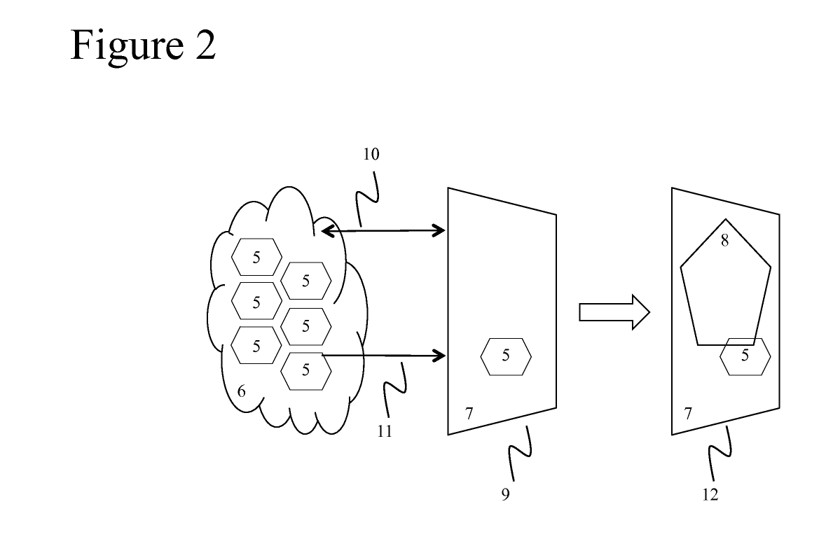

Turning to FIG. 2, with such a repository being accessible online, the Child Software Application 5 contents therein are freely searchable 10 and downloadable 11 by any Application Seeking Registrant (thereby becoming a Software Application Downloading Party 7) or any similarly permission holding party authorized by the System Administrator 1. Once downloaded to the Software Application Downloading Party's 7 local hosting environment 9, the Child Software Application 5 can be opened, read, and interacted with as a stand-alone application (e.g., Java, Android) or if need be opened, read, and interacted with via a Child Software Application Reader 8 co-located with the Child Software Application 5 within the Software Application Downloading Party's 7 local hosting environment 12 (e.g., the Software Application Downloading Party's 7 own computer system).

Upon download, the Software Application Downloading Party's 7 is free to run Child Software Applications 5 and input its own data in fields where the Parent Software Generator User 4 has specified that such inputs be permitted. Similarly, Child Software Applications 5 can be authored by the Parent Software Generator User 4 in such a way that instructions for external data feeds are embedded within Child Software Applications 5 and capable of incorporating such streams once opened by the Software Application Downloading Party 7 in the locally hosted environment 12. In the alternative, Child Software Applications 5 can be authored by the Parent Software Application User 4 in such a way that instructions for external data feeds are determined by the Software Application Downloading Party 7 subsequent to the Software Application Downloading Party 7 opening the Child Software Application 5. In either case, the data feeds may be free or paid for by the System Administrator 1, the Parent Software Generator User 4, the Software Application Downloading Party 7, another third party (e.g., an application agent or sponsor), or any combination thereof.

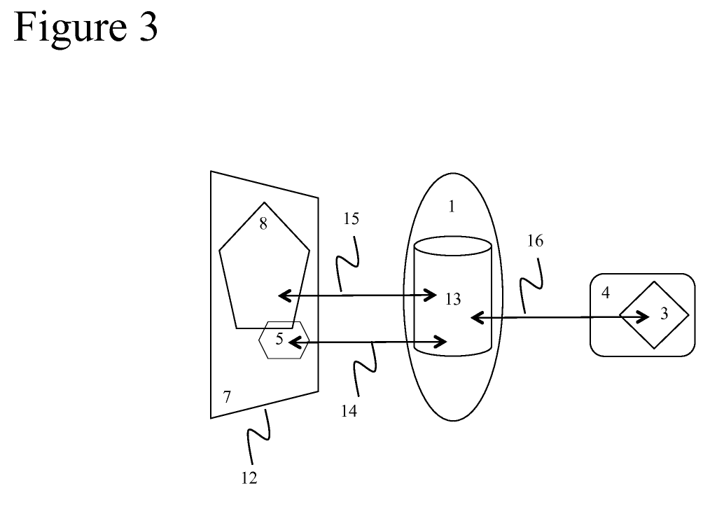

As seem in FIG. 3, once the Software Application Downloading Party 7 has reviewed and/or interacted with the Child Software Application 5, the Child Software Application 5 will allow the Software Application Downloading Party 7 to communicate directly (peer-to-peer), and if requested anonymously, with the Parent Software Generator User 4 that created the Child Software Application 5 and who is associated with the financial instrument represented by the Child Software Applications 5. Further, such communications can be encrypted by the system or not, or only encrypted at certain stages by the system, and further such communication characteristics can be determined at the instruction of (and discretion of) any one or more of the System Administrator 1, the Software Application Downloading Party 7, or the Parent Software Generator User 4. Throughout this process, the System Administrator 1 is facilitating these communications by having a system Message Server 13 route communication data flows between the various communicating parties, whether the messages be created or received by a Child Software Application 5 itself, the Child Software Application Reader 8 that supports such a Child Software Application 5, or the Parent Software Generator User 4 (represented by arrows 14, 15, and 16 respectively).

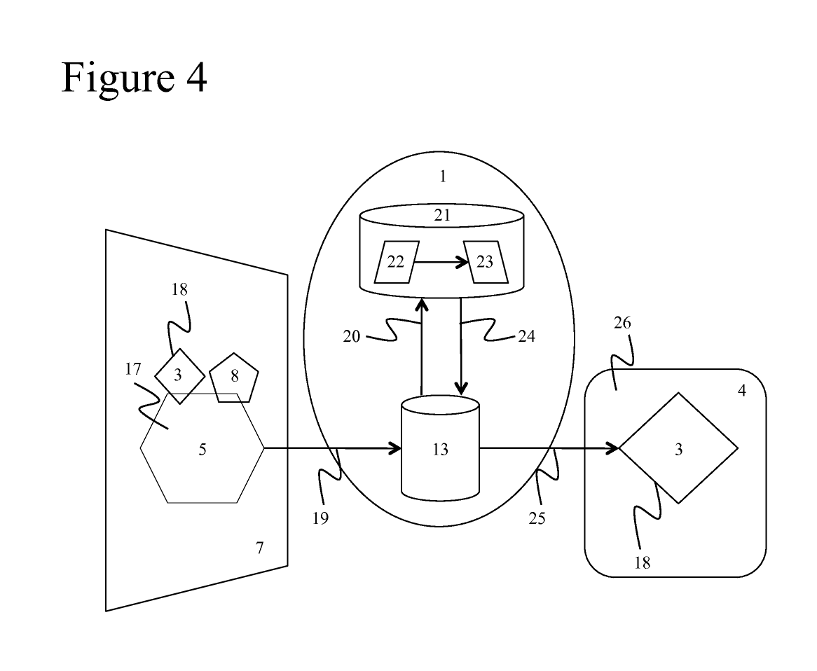

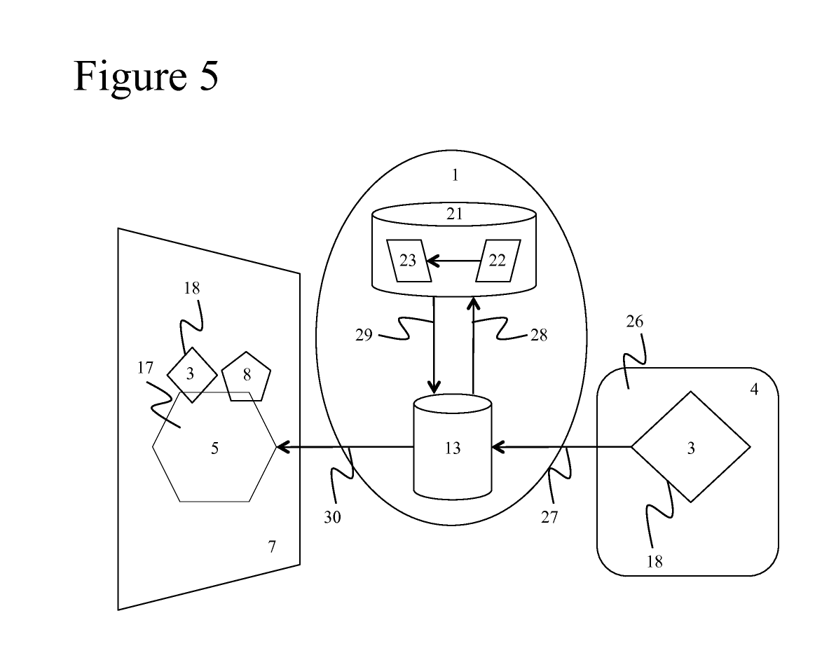

As a general rule, in the most basic embodiment of the Invention (see FIG. 4), communications from the Software Application Downloading Party 7 to the Parent Software Generator User 4 (and vice versa as seen in FIG. 5) are to be anonymous unless one or more of the communicating parties volunteers to disclose their identity to the other party. The process of preserving anonymity is based on having the various identification codes (Parent Software Generator Identification Code 18, Child Software Application Identification Code 17, Parent Software Generator User Identification Code 26, Application Seeking Registrant Identification Code, and/or Child Software Application Downloading Party Identification Code) being stored in a separate User Identification Code Databases 22 associated with the Message Server 13 and having the actual corresponding name and addressing information for the various participants being stored in a distinct and secure User Addressing Databases 23 also associated with the Message Server 13 (and in one embodiment both User Identification Code Databases 22 and the User Addressing Databases 23 are housed within one Computer Sub-Subsystem 21), and having the User Identification Code Databases 22 being able to coordinate communication instructions 19 received by the Message Server 13 from the Child Software Application 5 (whether or not enabled by a Parent Software Generator 3 or a Child Software Application Reader 8) and subsequently routed from the message sever 13 via path 20 to the User Identification Code Databases 22 and forwarded to the User Addressing Databases 23 which then relays via path 24 the communication data back to the Message Server 13 for further delivery via path 25 to the Parent Software Application User 4 utilizing the Parent Software Generator 3 as its peer-to-peer system messaging component. As a result, the message being delivered to the recipient is capable of being stripped of any identifying meta data by the system that would prevent the in-system communication from being anonymous from the perspective of the party sending the communication (the Software Application Downloading Party 7) and the party receiving the communication (the Parent Software Generator User 4). However, the system also allows for either party (or both parties) to identify itself (instructing the Invention to not strip out identification data) at anytime prior to or immediately following a communication data flow process, thereby enabling complete or unilateral non-anonymous communication flows at any time.

As seen in FIG. 5, the message flow is reversed from the flow described in FIG. 4 (the communication flow moving from the Parent Software Generator User 4 to the Software Application Downloading Party 7), yet invoking the same elements of the system described and shown on FIG. 4. In FIG. 5 the process of preserving anonymity is again based on having the various identification codes (Parent Software Generator Identification Code 18, Child Software Application Identification Code 17, Parent Software Generator User Identification Code 26, Application Seeking Registrant Identification Code, and/or Child Software Application Downloading Party Identification Code) being stored in the separate User Identification Code Databases 22 associated with the Message Server 13 and having the actual corresponding name and addressing information for the various participants being stored in a distinct User Addressing Databases 23 also associated with the Message Server 13 (and in one embodiment both User Identification Code Databases 22 and the User Addressing Databases 23 being housed within one computer Sub-Subsystem 21), and having the User Identification Code Databases 22 being able to coordinate communication instructions 27 received by the Message Server 13 from the Parent Software Generator 3 and subsequently routed from the message sever 13 via path 28 to the User Identification Code Databases 22 and forwarded to the User Addressing Databases 23 which then relays via path 29 the communication data back to the Message Server 13 for further delivery via path 30 to the Child Software Application 5 (whether or not enabled by a Parent Software Generator 3 or a Child Software Application Reader 8 being utilized as its peer-to-peer system messaging component). As a result, the message being delivered to the recipient is capable of being stripped of any identifying meta data by the system that would prevent the in-system communication from being anonymous from the perspective of the party sending the communication (the Parent Software Generator User 4) and the party receiving the communication (the Software Application Downloading Party 7). However, the system also allows for either party (or both parties) to identify itself (instructing the system to not strip out identification data) at anytime prior to or immediately following a communication data flow process, thereby enabling complete or unilateral non-anonymous communication flows at any time.

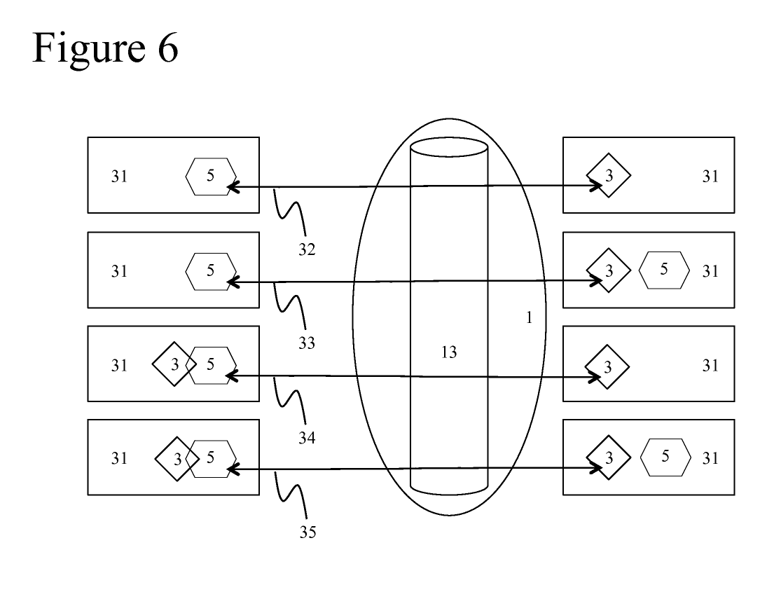

Further, the Invention enables various market participants to act as either only Application Seeking Registrants, Software Application Downloading Parties 7, or Parent Software Generator Users 4, or as any combination thereof (e.g., Application Seeking Registrant and Parent Software Generator User 4). However, at all times the parties engaging to use the system are actual or prospective Financial Instrument Market Participants 31 (e.g., brokers, dealers, institutions, buy-side institutions, sell-side institutions, counterparties, regulators, or analogous) and can communicate in a variety of ways using various elements of the Invention. Specifically, looking at FIG. 6 the block diagram shows four communication scenarios where the Financial Instrument Market Participants 31 may communicate with each other using the following combination of system elements: (a) where one Financial Instrument Market Participant 31 communicates via path 32 from a Child Software Application 5 through the Message Server 13 with another distinct Financial Instrument Market Participant 31 utilizing a Parent Software Generator 3; (b) where one Financial Instrument Market Participant 31 communicates via path 33 from a Child Software Application 5 through the Message Server 13 with another distinct Financial Instrument Market Participant 31 utilizing a Parent Software Generator 3, but where the other distinct Financial Instrument Market Participant 31 is also a Child Software Application Downloading Party 7; (c) where one Financial Instrument Market Participant 31 communicates via path 34 from a Child Software Application 5 (supported by a Parent Software Generator 3) through the Message Server 13 with another distinct Financial Instrument Market Participant 31 utilizing a Parent Software Generator 3; and (d) where one Financial Instrument Market Participant 31 communicates via path 35 from a Child Software Application 5 (supported by a Parent Software Generator 3) through the Message Server 13 with another distinct Financial Instrument Market Participant 31 utilizing a Parent Software Generator 3, but where the other distinct market participant is also a Child Software Application Downloading Party 7.

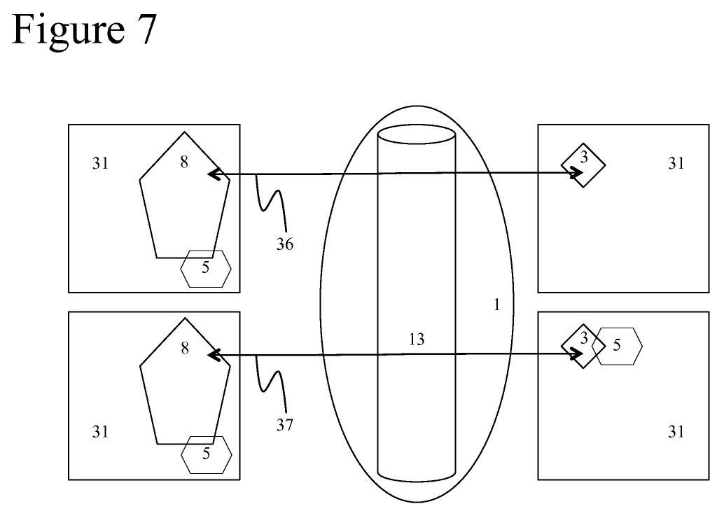

Similarly, in FIG. 7 two more options are envisioned by the system for Financial Instrument Market Participants 31 to communicate: (a) where one Financial Instrument Market Participant 31 communicates via path 36 from a Child Software Application 5 (supported by a Child Software Application Reader 8) through the Message Server 13 with another distinct Financial Instrument Market Participant 31 utilizing a Parent Software Generator 3; and (b) where one Financial Instrument Market Participant 31 communicates via path 37 from a Child Software Application 5 (supported by a Child Software Application Reader 8) through the Message Server 13 with another distinct market Financial Instrument Market Participant 31 utilizing a Parent Software Generator 3, but where the other distinct market participant is also a Child Software Application Downloading Party 7. However, those versed in the art will envision other use case combinations where Financial Instrument Market Participants 31 will mix and match tools to communicate in an efficient and suitable manner.

As such, no actual execution, settlement, or clearing need be consummated through the preferred embodiment of the Invention. Instead, the Invention in its most simple embodiment merely enables the unlimited sharing of financial instrument characteristics (growing the number and diversity of financial instruments as well as growing the number of parties willing to create a market in such financial instruments) and where there is interest in acquiring such a financial instrument puts the relevant parties in contact with each other for purposes of arranging an “outside the system” sale of the financial instrument represented by the Child Software Application 5.

If needed, however, the current Invention can also incorporate a execution function where the sale of a financial instrument represented by a Child Software Application 5 is consummated (actual consideration passes between the Financial Instrument Market Participants 31), with such consummation being done by the Invention itself or handed off to a third party (e.g., a clearing or settlement agency) by the System Administrator 1. In this regard, the system could handle all (end to end) or only parts of the execution processes, including but not limited to functions relating to making offers, counter offers, acceptances of offers, full or partial payment between the parties (or their agents) for agreed offers, transfer of title relating to consummated transactions, and analogous.

Similarly, the system can serve as a regulatory reporting and market monitoring tool by having data within the system be aggregated (anonymously, partially anonymous, or not anonymous) and provided to regulatory bodies seeking to have monitoring, supervision, and/or management capabilities with regard to a set of financial instruments and associated market participant activity within the market.

As previously described, the Parent Software Generator 3 is created specifically by the System Administrator 1 for a Parent Software Generator User 4 (perhaps the owner of an existing economic contract or financial instrument generating a particular “benefit” or “expectation” for that owner, or in the alternative, a party that is willing to create such a contract or financial instrument and sell its economic expectation onward to another party as part of a new transaction) who wishes to use the Parent Software Generator 3 to create a unique Child Software Application 5 that virtualizes the characteristics of the contract or financial instrument in question (whether such contract or financial instrument is existing or merely contemplated) so that others may download and interact with such a Child Software Application 5 and may learn of its existence and ascertain whether they wish to purchase such contract or financial instrument (or request the creation of a similar contract or financial instrument) from the Parent Software Generator User 4 or another party associated with the Parent Software Generator User 4.

In some instances, the delivery of the Parent Software Generator 3 to the Parent Software Generator User 4 may be through a web-based front-end (an online portal, home page, hosting environment, or analogous) for consideration being paid for such service to the provider and/or creator of the Parent Software Generator 3 (e.g., the System Administrator 1) and possibly having further consideration being paid to the System Administrator 1 being tied to market activity generated by the Parent Software Generator's 3 existence (e.g. commissions based on the number of Child Software Applications 5 downloaded by system users, or the number and/or type of messages generated by system users pertaining to a particular Child Software Application 5).

For the avoidance of doubt, the Parent Software Generator 3 is capable of creating any number of stand alone applications (Java, Android, webOS, MeeGo, iPhone, Windows, etc.) or similar applications that need to be run within another software application envelope (such as the Parent Software Generator 3 or the Child Software Application Reader 8).

In terms of the information that may be incorporated into the Child Software Application 5 by the Parent Software Generator 3 pursuant to the instructions of the Parent Software Generator User 4, the Invention contemplates that any type of financial instrument or contract documentation and terms may be included, with or without information relating to counterparties and other affiliate information. Of note, the Child Software Application 5 may also have the ability to communicate dynamic market relevant information that may be modified automatically or manually, and make use of one or more pre-determined formula for determining size and tenure of contract benefit, as well as counterparty risk measurements.

The Invention also contemplates using application programming interfaces (“APIs”) to enable direct importation of requisite data feeds (e.g. Bloomberg feeds), as well as manual input fields to enable a user of the Child Software Application 5 to override requisite data feeds or static formula assumptions where the user does not have access to, or does not wish to use such requisite data feeds.

The Invention also envisions the use of an encrypted two-way communication mechanism to allow a user of the Child Software Application 5 to communicate directly with another system user of counterparty for purposes of receiving additional information, to request a quote to purchase such contract or financial instrument (or a similar one), to offer a bid to purchase such contract or financial instrument (or a similar one), and/or suggest a method of executing on a potential transaction relating to such contract or financial instrument (or a similar one), whether via a face-to-face exchange or through a third-party intermediary to shield one or more of the identifies of the negotiating parties, or some analogous mutually acceptable method.

Further, the Invention has the ability to easily upload a Child Software Application 5 to the System Administrator's 1 Online Storage Facility 6 by the Parent Software Generator User 4 using the Parent Software Generator 3 and thereafter downloaded by a Application Seeking Registrant or Child Software Application Downloading Party 7 who has registered with the system.

The Invention also makes use of descriptive keyword notations made by the Parent Software Generator User 4 during the Child Software Application 5 creation process that can be used to populate a system registry with key words linked to such a Child Software Application 5 that are searchable by a system user wishing to find, review, and/or download a particular type of Child Software Application 5 dealing with a particular financial instrument. Further, such search mechanism can allow the searching party the ability to partially review the Child Software Application 5 within the Online Storage Facility 6 prior to download of the Child Software Application 5.

In addition, the System Administrator 1 can maintain the Invention (creation and delivery of the Parent Software Generator 3, creation and storage of all identification codes tied to system software elements and the users of such system software elements, the storage of Child Software Applications 5, the shepherding of anonymous (or non-anonymous) messages between Parent Software Generator Users 4 and Child Software Application Downloading Parties 7 for free, on a subscription basis, and/or a performance basis as the case may be (facilitation of price and party discovery).

In one embodiment, one or more of the Child Software Applications 5 and the Parent Software Generator 3 will have an “offer” function (e.g. a virtual button) that will be used when a final offer (quantum, price, and special terms set forth in accompanying document attachments or message text) is forwarded from a Child Software Application Downloading Party 7 to a Parent Software Generator User 4 (all Financial Instrument Market Participants 31) or vice versa. Where a Financial Instrument Market Participant 31 submits an offer via the “offer” function, the Message Server 13 will recognize such and deliver the offer to the other Financial Instrument Market Participant 31 (e.g., the Child Software Application Downloading Party 7 or the Parent Software Generator User 4) along with a secure link to an application associated web-based confirmation registry where the relevant Financial Instrument Market Participant 31 will select from a “refuse” or “acceptance” function that will deliver a confirmed refusal or acceptance to the offering Financial Instrument Market Participant 31 (e.g., the Parent Software Generator User 4 or the Software Application Downloading Party 7). Where an offer is accepted, the Invention's System Administrator 1 will prepare and deliver to one, some or all of the Child Software Application Downloading Party 7, Parent Software Generator User 4 or their agents an invoice for the amount of commission pre-agreed with the Invention's System Administrator 1 at the time the Parent Software Generator 3 was created and delivered to the Parent Software Generator User 4. Further, this function can be managed by the Invention's System Administrator 1 itself or can be outsourced to an entity (unregulated or regulated) specializing in executing such transactions.

In another embodiment, where the transaction as facilitated by the Invention fails to be consummated (inside or outside the system by the parties and/or agents to the parties), the commission could be refunded to the Parent Software Generator User 4 (or other parties so entitled to such a refund) if notice is given to the Invention's System Administrator 1 within a set period of time and upon adequate proof of the failure to consummate the transaction.

In the alternative, the Invention contemplates the addition of an execution component whereby the Invention's System Administrator 1 also engages in the actual sale consummation of the contract or financial instrument from one party to another. While this increases the functional requirements of the Invention (and operational costs and risks for the Invention's System Administrator 1), it also ensures that the commission to the Invention's System Administrator 1 for a consummated transaction is paid at the time of such transaction.

In addition to the improving the markets for financial instruments (including but not limited to complex financial instruments, non-standard financial instruments, derivative instruments such as swaps, futures, and options, and analogous), the current Invention can also serve as the facilitation mechanism for other alternative and/or non-alternative financial instruments like equities, bonds, loans, energy credits (e.g. renewable energy credits), pollution credits (e.g. carbon credits), weather contracts, tax credits, and other asset and liability representations of value that would be better served by the current Invention as opposed to being traded over a centralized exchange, clearinghouse, or through non-application enabled peer-to-peer market making (e.g. traditional brokerage operations that use a host of techniques distinct from the current Invention to facilitate transactions in that particular instrument).

Similarly, while the present invention has numerous embodiments that facilitate peer-to-peer financial instrument contract creation and/or title transfer, the invention also is capable of facilitating (i) non-financial instrument contract creation and title transfer and (ii) quasi-financial instrument contract creation and title transfer, such as peer-to-peer agreements relating to electronic gaming and event wagering, whether such agreed upon event outcomes (including consequent liabilities and entitlements accruing to participating parties who have taken asset positions relative to particular event outcomes) deal with card games, board games, fixed-odds betting, parimutuel betting, prediction markets, spread betting, sport betting, horse race betting, dog (e.g., greyhound) race betting, political outcome betting, arbitrage betting, event betting, weather betting, commodity betting, financial market betting, back bets, lay bets, or analogous types of wagering.

The use of “one application per one financial instrument” technique also bolsters the ability of the System Administrator 1 to offer a low cost, secure, and efficient anonymous financial instrument discovery and price negotiation prior to execution, and then peer-to-peer trades (over the counter type) executions thereafter (e.g., outside of the system through an independent settlement function, or within the system) but with greater transparency than the status quo. It is also possible that the current Invention will promote the creation of even more transparent data for certain difficult to value markets when compared to an existing centralized framework since more people might participate in the Invention's system due to the availability of free data streams, low cost participation, and ease of use.

The current Invention also benefits from certain “social networking” aspects in that it enables participants to not only signal to other Financial Instrument Market Participants 31 their own credibility within the financial instrument markets, but it allows Financial Instrument Market Participants 31 to ascertain the quality of counterparties that they may choose to engage with prior to actually communicating with them directly. Specifically, the current Invention contemplates several unique vetting functions that can be used in a plurality of scenarios to better serve all Financial Instrument Market Participants 31 as they assess the pros and cons of engaging with a particular market participant, whether they be an actual or prospective counterparty, agent, advisor, or other entity, and to engage in this vetting process while one or both of the communicating parties remains anonymous.

Of note, the Invention has several unique features that encourage Parent Software Generator Users 4, requesting parties, and Application Seeking Application Seeking Registrants 7 to create, share, review, and communicate data relating to their prospective or existing financial instruments virtualized within their Child Software Applications 5, and likewise encourage one, some or all of the Child Software Application Downloading Party 7, Parent Software Generator User 4, and the Application Seeking Registrant to share certain system usage information about themselves with other system users prior to or during the course of their online interactions via the Invention. By encouraging these behaviors, the current Invention will become more valuable to users as the number of Child Software Applications 5 created, uploaded, downloaded, and reviewed increases, and similarly, the system will be more effective for providing transparency and discovery with greater communication engagements between Financial Instrument Market Participants 31 (the number of anonymous and non-anonymous messages being sent from and to respective system users via the Invention).

To encourage the system users to generate more content (Child Software Application 5 creation) and interact more frequently and in a more qualitative manner around such content (improved messaging, analysis, sharing of data) the Invention can also enable system users to generate certain usage statistics and ranking tables describing their own system use behaviors and share that with others (sharing this data internally within the system via user or system generated and published or downloaded reports or externally through other social networking platforms such as Facebook, Google+, LinkedIn, or otherwise). In this way, each Child Software Application 5 can be provisioned with customized usage behavior statistics pertaining to the system activities of that particular creator of that particular Child Software Application 5 (the Parent Software Application User 4). For some Child Software Application 5 created, this creator may wish to share many aspects of their system usage behaviors; in another Child Software Application 5 so created, perhaps less details may be shared. The Child Software Application 5 reviewer (the Child Software Application Downloading Party 7 and Application Seeking Registrant) can then look at these rankings and decide whether this is a party they wish to communicate with initially or on an ongoing basis. Similarly, the reviewers of the Child Software Application 5 may wish to share similar information about their own system use statistics with the creator of the Child Software Application 5 (the Parent Software Application User 4) they wish to communicate with (again, varying the amount of use data they share with such Parent Software Generator User 4 based upon the circumstances surrounding the Child Software Application 5 being reviewed and generating the appropriate anonymous or non-anonymous communication.

As a practical matter, this system usage data is created by the System Administrator 1 by aggregating information provided within each Child Software Application 5 and Parent Software Generator 3 (from the same data set that was used to create the Child Software Application 5) along with the upload, download, and messaging trails resulting from the Child Software Application 5 creation, upload, download, and review process managed by the system.

In terms of how the this information is customized by the Child Software Application 5 creator (the Parent Software Application User 4) and the Child Software Application 5 reviewer (the Child Software Application Downloading Party 7) in the course of using the system, both the Parent Software Generator 3 and resulting Child Software Application 5 will have buttons, tick boxes, and other input functions embedded therein which can allow each user to customize their statistical profile as shared with the other party. Clearly, the more data that is shown by one party to the other, the greater the likelihood that such party will feel comfortable interacting with that other party. Similarly, the more active a particular party is (as denoted by the usage statistics shared and perhaps their ranking in that regard compared to other system users), the greater the likelihood that other parties will choose to interact with them as opposed to another party offering a similar application (e.g., the more active you are within the system in terms of Child Software Applications 5 created, uploaded, downloaded, messages sent, and messages received, the greater the likelihood of attracting new interactions from other system users). Along with the “application-centric” design of the Invention, this unique system usage ranking capability will be a key differentiator for the Invention and increase its utility.

In this regard, the following is a outline of some of the system usage features that can be incorporated into the Invention's Parent Software Generator 3 and/or resulting Child Software Application 5, beginning with a feature set to be incorporated within the Parent Software Generator 3 comprised of an interactive input page (e.g., also tied to a messaging function) featuring any one or more of ranking profile data interactive tick boxes (or analogous) where the Parent Software Generator User 4 can select their own system use and market characteristic rankings data to be shared with the Child Software Application 5 downloading community when they find this particular Child Software Application 5. Of note, the statistical information that can be collected and shared includes (but is not limited to): (i) the number of Child Software Applications 5 uploaded by that particular Parent Software Generator User 4; (ii) the number of Child Software Applications 5 downloaded by that particular Parent Software Generator User 4; (iii) the number of messages received by that particular Parent Software Generator User 4 related to their created Child Software Applications 5; (iv) the number of messages sent back by the that particular Parent Software Generator User 4 relating to their created Child Software Applications 5; (v) the notional value of the Child Software Applications 5 created by that particular Parent Software Generator User 4; (vi) the geographic spread of that particular Parent Software Generator User's 4 Child Software Applications 5 created (where their financial instruments are originated); and (vii) the statistical breakdowns of the types of underlying instruments that particular Parent Software Generator User 4 created in the course of creating such Child Software Applications 5 (equity/debt/interest rate/currency/commodity/other analogous characteristics).

Similarly, within the downloaded and opened Child Software Application 5 (whether opened by itself as a stand alone application or with the support of a Child Software Application Reader 8 or with the support of a Parent Software Generator 3) the Invention also contemplates the inclusion of an interactive input page (e.g., also tied to a messaging function) featuring any one or more of ranking profile data interactive tick boxes (or analogous) allowing the messaging party (the Child Software Application Downloading Party 7) to share their own system use characteristics and rankings with the Parent Software Generator User 4 that created that particular Child Software Application 5 thereby encouraging that particular Parent Software Generator User 4 to respond to any messages sent by the Child Software Application Downloading Party 7 from that particular Child Software Application 5, including: (i) the number of Child Software Applications 5 downloaded by that particular Child Software Application Downloading Party 7; (ii) number of messages sent by that particular Child Software Application Downloading Party 7 to various Parent Software Generator Users 4; (iii) the number of messages received by that particular Child Software Application Downloading Party 7 from contacted Parent Software Generator Users 4; (iv) the notional and average value of the Child Software Applications 5 that particular Child Software Application Downloading Party 7 has downloaded via the system; (v) the geographic spread of Child Software Applications 5 downloaded by that particular Child Software Application Downloading Party 7 (e.g., where those financial instruments were originated), and; (vi) the statistical breakdowns of the types of underlying instruments that particular Child Software Application Downloading Party 7 downloaded via the system (equity/debt/interest rate/currency/commodity/other analogous characteristics).

Similarly, the following represents additional unique features that can be incorporated into the Invention's Parent Software Generator 3 and resulting Child Software Application 5. Of note, the Invention contemplates that within the Parent Software Generator 3 there be included of an interactive input page comprised of: (a) an interactive tick box (or analogous) stating whether the Child Software Application 5 being created by the Parent Software Generator 3 represents an actual financial instrument on the books of the Parent Software Generator User 4 or is a sample of a financial instrument they are capable of creating (this is an important point for purposes of searching and possible regulatory reporting down the road in various jurisdictions); (b) a set of interactive tick boxes (or analogous) (for Company X, Company Y, Company Z) where the Parent Software Generator User 4 can be e-mailed/informed of information about a trial or low cost subscription to a data feed service relating to the creation of the Child Software Application 5; (c) a set of interactive tick boxes (or analogous) (for Company A, Company B, Company C) where the Parent Software Generator User 4 can be e-mailed/informed of information about a trial or low cost settling or clearing function relating to the creation of the Child Software Application 5; and (d) a set of interactive tick boxes (or analogous) (for Company 1, Company 2, Company 3) where the Parent Software Generator User 4 can select how they want their Child Software Application 5 to be reported to a regulatory body or agency if need be.

Similarly, within the “opened” Child Software Application 5 the inclusion of an interactive input page (likely tied to a messaging function) comprised of: (a) a set of interactive tick boxes (or analogous) (for Company X, Company Y, Company Z) where the Child Software Application 5 reviewer can be e-mailed/informed of information about a trial or low cost subscription to a data feed service relating to the Child Software Application 5 being reviewed; (b) a set of interactive tick boxes (or analogous) (for Company A, Company B, Company C) where the Child Software Application 5 reviewer can be e-mailed/informed of information about a trial or low cost settling or clearing function relating to the Child Software Application 5 being reviewed; and (c) a set of interactive tick boxes (or analogous) (for Company 1, Company 2, Company 3) where the Child Software Application 5 reviewer can select how they want their resulting Child Software Application 5 (for a new deal) to be reported to a regulatory body or agency if need be.

Taken as a whole, this type of data collection can not only assist system users in determining the quality and characteristics of other system users and their authored content prior to engaging with them, but can also assist the System Administrator 1 as it rolls out different versions of the Invention in different markets, collect different data sets for analysis or to satisfy regulatory requirements, or to offer new commercial terms to its own customers (e.g., upload fees for Child Software Applications 5 varying upon the actual number of Child Software Applications 5 created by that particular Parent Software Generator User 4 and uploaded within a set period of time, messaging fees for Child Software Application Downloading Party 7 varying upon the actual number of Child Software Application 5 messages sent by that Child Software Application Downloading Party 7 within a set period of time, messaging fees for Parent Software Generator Users 4 varying upon the actual number of reply messages sent by that Parent Software Generator User 4 within a set period of time, the waiving of Child Software Application 5 upload fees for a set period of time to encourage new users to populate the system with Child Software Applications 5, and other commercial system use structures whether based upon one or more of the number of messages sent, Child Software Applications 5 uploaded, Child Software Applications 5 downloaded, the length of time such Child Software Applications 5 are in the system's Online Storage Facility 6, the notional deal size of the financial instrument represented by the Child Software Applications 5, the various commercial characteristics of the financial instrument represented by the Child Software Applications 5, or otherwise and that those versed in the art can contemplate).

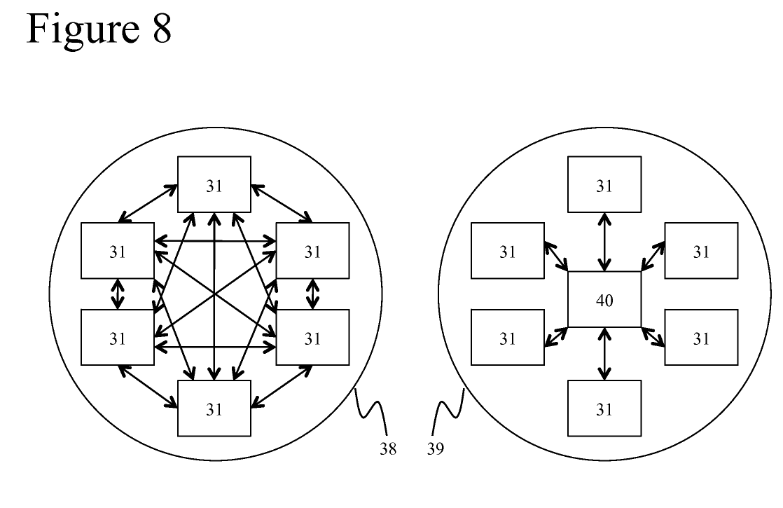

In light of the aforementioned description, it should be clear to those in the field that the current Invention is unique and differentiated from the prior art concerning platforms for finding, accessing, and transacting in financial instruments. Further to this point and by way of background, FIG. 8 shows two common financial instrument trading mechanisms currently used by the markets. The first, represented by grouping 38 represents the transactional relationships observed in a traditional peer-to-peer “over the counter” market. In such a market, each counterparty (usually a financial institution or large company) has bilateral trading agreements with each of the others based upon personal relationships. In this system, each counterparty knows only its trades (contracts or financial instruments) with the other party and not that party's trades with the other counterparties or other trades generally within the system. Further, while some of the execution and back-office functions relating to these over the counter transactions are electronically automated, the front-end discovery and origination process (finding the financial instrument, finding the counterparty, assessing the instrument and the counterparty prior to communicating with them, negotiating terms, etc.) is not electronically automated and instead relies on the existence of traditional social networks between market participants utilizing a variety of non-unified communication techniques (e.g., ad hoc use of phone, fax, e-mail).

Historically, this model can handle both standard and complex/customized transactions in financial instruments, but is limited in its ability to quickly generate valuable market relevant information, such as an indication of a “bid” or an “ask” without the intervention of a broker, and is severely limited in its ability to create new networks of parties that may wish to engage with each other on a peer-to-peer basis. In short, the strengths of the current over the counter market are that there is trading flexibility for trading non-standard financial instruments, relatively low maintenance costs for owners of financial instruments, and flexible mark to market for financial instrument owners (“mark to model”). However, this over the counter market has significant weakness due to its inability to quickly produce efficient pricing data and volume transparency, suffers from poor liquidity, is limited to bilateral netting between counterparties, does not have an efficient means of integrating relevant data feeds into the analytical portions of the financial instruments, and usually requires the services of an intermediary broker or dealer that charges a significant fee or commission to set-up and execute a transaction relating to the financial instrument.

Turning to the second block diagram on FIG. 8 representing a centralized trading and clearing system 39, one can also see severe limitations that the current Invention addresses and is unique in comparison. Of note, with a central platform, each counterparty trades with or through a central party who often assumes the financial risk associated with doing a transaction between the two counterparties. And for some financial instruments (standardized instruments such as well known listed equities) this type of hosting environment provides good transparency on prices and volumes. In this sense, this model (clearinghouses and exchanges) are best structured for handling standardized trades. However they are not effective at handling non-standard financial instruments or complex/customized contracts as they are too costly to list (the traditional central platform will charge a considerable amount to list, price, and/or settle the trade), and trading volumes will be too low to justify this cost from the prospective of the party creating the financial instrument. So, in the case of a central model dealing with well-known and standardized financial instruments, there are strengths relating to pricing and volume transparency and liquidity, solid mark to market valuation mechanisms, the ability for counterparties to net out their positions vis-à-vis one another, the ability of such exchanges to be electronically automated, and their ability to manage counterparty risk (trade execution guarantees by the operator of the centralized exchange or facility). However this system has weakness when it tries to manage non-standardized financial instruments since putting many types of non-standardized financial instruments into such a centrally managed system has integration and maintenance costs that are too high for financial instrument owners, they are difficult and expensive to build since they require a level of quality of service and speed that is difficult to assure for all participants, they are not well-suited to handle complexity in terms of the financial instrument types brought into the system, sharing of key documentation is very difficult to achieve, only the largest entities can afford to participate in such systems (making markets less efficient for all parties), and the exchanges and clearing systems must be heavily regulated and are therefore expensive to build and maintain in a manner that satisfies regulatory needs.

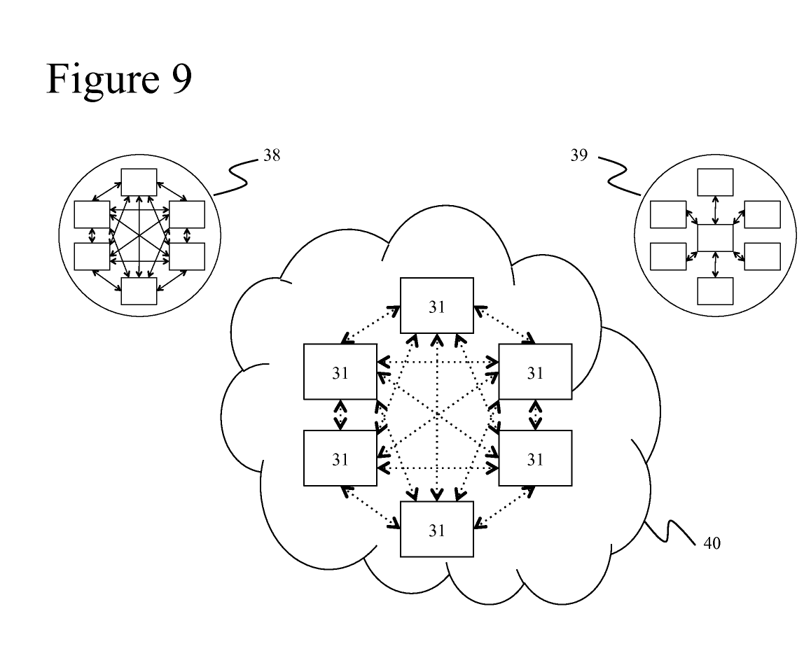

Against this background the current Invention is unique in that it is able to apply electronic automation capabilities to key functions within an over the counter, peer-to-peer market (e.g., via the quick and low-cost authoring of searchable and downloadable Child Software Applications 5 by Financial Instrument Market Participant 31 who can communicate securely and discreetly amongst each other) without incurring the cost of building a very expensive centrally traded or cleared marketplace. Turning to FIG. 9 one can see this in the block diagram group 40 where counterparties can engage with each other on a peer-to-peer basis—much like the existing over the counter market seen in group 38, but do so utilizing novel social networking and peer-to-peer communications.

In this sense, the current Invention combines the peer-to-peer capabilities of group 38 and the electronic automation capabilities of group 39, and ties the two together through a unique system of application toolkits (the Parent Software Generator 3), user-generated and user-published virtual financial instruments (the Child Software Application 5), the secure Message Server 13, the search term data base for finding relevant applications, the User Identification Code Databases 22, the User Addressing Databases 23, and the other technical innovations described herein.

Additionally, a novel aspect of the invention is the representation of a financial instrument by an autonomous software application wherein one embodiment the market participant is assigned a unique identification code associated with an assumed name chosen by the participant upon registering with the System Administrator 1, and wherein said system assigns different unique identification codes to the same market participant for multiple registrations relating to the creation of multiple Child Software Applications 5.

Another novel aspect of the Invention is the integration of all workflow into a centralized and integrated program (e.g., a DerivaLink or analogous) wherein participants can search and download the Child Software Applications 5 from a web browser, and execute the Child Software Applications 5 to view its attachments and send outbound messages. In this regard, the DerivaLink element provides a centralized cockpit from which participants can register for different unique identification codes, create and upload Child Software Applications 5, send outbound messages and receive inbound messages, and search, download, and execute published Child Software Applications 5 from the Online Storage Facility 6.

Another novel aspect of the invention is the anonymity and security in the communication among participants. Information—including but not limited to electronic mail addresses, phone numbers, and mailing addresses—supplied by participants at the time of registration with the system can be qualified as “public”, “private”, or “by request” by the respective participants. “Public” information is available to all Participants. “Private” information is available to only the System Administrator 1, and access to “by request” information can be granted on a case by case basis by one participant to another. When inbound and outbound messages are exchanged, only the assumed names are known to participants. Message contents are encrypted using the public key that is created for or derived from the sending or receiving participant unique identification codes. It is important that even the originating IP addresses of one participant' computer cannot be traced by another participant. Therefore, all messages among participants are relayed through the Message Server 13. It is further novel that even though the Message Server 13 relays the messages, it itself does not have the necessary security credential to view the said messages' contents. As such, the credentials are solely the properties of the sending and receiving participants' utilizing their unique identification codes.

In summary, the advantages of the current Invention are that it provides: (a) a unique and novel application based ecosystem that is far easier to code for complexity (exotic financial instruments are easier to create and negotiate); (b) a unique and novel application based ecosystem that is far easier to share documentation being “dragged and dropped” into the application during its creation process (using the toolkit); (c) a unique and novel application based ecosystem that is far cheaper to maintain across an entire platform (low cost and high quality security, speed, privacy and auditing provided for); (d) a unique and novel application based ecosystem that is far better suited to serving an entity that needs to communicate its position to others and to do so in a manner that has cost savings compared to traditional “listings” (resulting in more financial instruments being generated as well); (e) a unique and novel application based ecosystem that is far more open and allows any entity to review its contents (subject to situational specific permission requirements placed by the application creator); (f) a unique and novel application based ecosystem that leads to far better transparency on the bid and ask, which is good for mark to market and liquidity purposes (bids come in directly to seller via the application—not routed through an exchange), yet still permits users to utilize a “mark to model” if desired; (g) a unique and novel application based ecosystem that is far more capable of preserving various levels of anonymity to potential financial instrument sellers and buyers than found with other discovery platforms, with continued anonymity if agents are used to execute transactions (avoiding face to face engagements between counterparties); (h) a unique and novel application based ecosystem that is far more likely to encounter more modest regulatory constraints (if any); (i) a unique and novel application based ecosystem that is far more flexible where financial instruments are held by more than one seller since each seller can market their own holdings through their own customized Child Software Application 5 (and therefore can also request specialized bids), which can generate greater opportunity for tiered pricing and competition as well; (j) a unique and novel application based ecosystem that enables a data provider to be able to earn fees or commission for each financial instrument sale as opposed to subscription amount if data feeds embedded for free within an application that generates a transaction; (k) a unique and novel application based ecosystem that allows each application creator to get exposure to thousands of more clients globally with little or now cost; (l) a unique and novel application based ecosystem that has no specific requirement for Excel plug-ins or other software (however, the system does not prohibit such integrations); (m) a unique and novel application based ecosystem that can be used to actually solicit new financial instrument proposals (ability of a counterparty to post an application for a new kind of financial instrument into the market for review by potential counterparties); and (n) a unique and novel application based ecosystem that is operational on all device types (web platform suitable for mobile or fixed devices).

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method comprising:
a. in a computing system one or more Parent Software Generator capable of creating one or more customizable Child Software Application that serve to memorialize unique data sets pertaining to existing or prospective financial instruments, with such data sets provided to the Parent Software Generator for inclusion within the Child Software Application by the Parent Software Generator User;
b. in a computing system the ability of such Parent Software Generator to automatically publish such one or more completed Child Software Application to an Online Storage Facility;
c. in a computing system the ability of such Online Storage Facility to be searched by and results presented to one or more party seeking access to such one or more Child Software Application;
d. in a computing system the ability of such Online Storage Facility to electronically deliver to such one or more party seeking access to the one or more Child Software Application a copy of such one or more Child Software Application upon request by such one or more party seeking access to such one or more Child Software Application; and
e. in a computing system the one or more downloaded Child Software Application to be opened, run, and inspected remotely on the computer system of the one or more party seeking access to such one or more Child Software Application.

2. The computer-implemented method of claim 1, wherein each distinct Parent Software Generator disseminated via the system is assigned by the system its own unique Parent Software Generator Identification Code where that identification code is incorporated into that distinct Parent Software Generator.

3. The computer-implemented method of claim 1, wherein each distinct Parent Software Generator disseminated via the system is assigned by the system its own unique Parent Software Generator Identification Code where that identification code is incorporated into every Child Software Application thereafter created by that distinct Parent Software Generator.

4. The computer-implemented method of claim 1, wherein each Child Software Application created by a Parent Software Generator is assigned its own unique Child Software Application Identification Code by the Parent Software Generator and this unique Child Software Application Identification Code is incorporated by the Parent Software Generator into that particular Child Software Application so created.

5. The computer-implemented method of claim 1, wherein each Child Software Application created by a Parent Software Generator is assigned its own unique Child Software Application Identification Code by the Parent Software Generator and this unique Child Software Application Identification Code is recorded by the Parent Software Generator within the Parent Software Generator immediately following the creation of such Child Software Application.

6. The computer-implemented method of claim 1, wherein each Parent Software Generator User has been assigned their own unique Parent Software Generator User Identification Code by the system at the time the prospective Parent Software Generator User registers with the system.

7. The computer-implemented method of claim 1, wherein one or more party seeking access to such one or more Child Software Application may download from the System Administrator a Child Software Application Reader that is capable of any one or more of searching the Online Storage Facility, downloading Child Software Applications from the Online Storage Facility, reviewing the same from within the Child Software Application Reader, and facilitating message delivery between the one or more party who has downloaded and accessed the one or more Child Software Application and the Parent Software Application User that created the particular Child Software Application and perform these functions at the direction of the one or more party who has downloaded and accessed the one or more Child Software Application.

8. The computer-implemented method of claim 1, wherein the Parent Software Generator also has the ability to perform one or more of the functions of a Child Software Application Reader that is capable of any one or more of searching the Online Storage Facility, downloading Child Software Applications from the Online Storage Facility, reviewing the same from within the Parent Software Generator, and facilitating message delivery between the one or more party who has downloaded and accessed the one or more Child Software Application and the Parent Software Application User that created the particular Child Software Application and perform these functions at the direction of the one or more party who has downloaded and accessed the one or more Child Software Application.

9. The computer-implemented method of claim 1, wherein one or more party seeking access to a Child Software Application from the Online Storage Facility can be assigned a unique Child Software Application Downloading Party Identification Code by the system.

10. The computer-implemented method of claim 1, wherein one or more party seeking access to a Child Software Application from the Online Storage Facility is not assigned a unique Child Software Application Downloading Party Identification Code by the system.

11. The computer-implemented method of claim 1, wherein any one, some, or all of the Parent Software Generator Identification Code, Parent Software Generator User Identification Code, Child Software Application Identification Code, Application Seeking Registrant Identification Code, and the Child Software Application Downloading Party Identification Code are stored in a system registry that can be used to securely direct any specified combination of encrypted and unencrypted messages to and from the creators of one or more Child Software Application and the parties having downloading such one or more Child Software Applications from the Online Storage Facility.

12. The computer-implemented method of claim 1, wherein any one, some, or all of the Parent Software Generator Identification Code, Parent Software Generator User Identification Code, Child Software Application Identification Code, Application Seeking Registrant Identification Code, and the Child Software Application Downloading Party Identification Code are stored in a system registry that can be used to securely direct any specified combination of anonymous and non-anonymous messages to and from the creators of one or more Child Software Application and the parties having downloading such one or more Child Software Applications from the Online Storage Facility.

13. The computer-implemented method of claim 1, wherein the Parent Software Generator enables the Parent Software Generator User to memorialize unique data set information pertaining to existing or prospective financial instruments into the Child Software Application through the use of one or more interactive, subject matter defined dialog boxes pre-populated with descriptive subject matter check boxes, drop-down lists, radio buttons, text boxes, drag and drop fields for electronic documents, and analogous user interface elements that are used to populate a software application with external information provided by a Parent Software Generator User.

14. The computer-implemented method of claim 1, wherein the Parent Software Generator enables the Parent Software Generator User to memorialize unique data set information pertaining to existing or prospective financial instruments into the Child Software Application through the use of one or more interactive, subject matter defined dialog boxes with amendable pre-populated defined descriptive subject matter check boxes, drop-down lists, radio buttons, text boxes, drag and drop fields for electronic documents, and analogous user interface elements that are used to populate a software application with external information provided by a Parent Software Generator User.

15. The computer-implemented method of claim 1, wherein the Parent Software Generator enables a Parent Software Generator User to lock down further changes to the Child Software Application so created and thereafter be searchable by and downloadable by one or more party seeking access to such Child Software Application but not capable of disclosing its unique data set contents to such one or more party seeking access to such Child Software Application absent having the party seeking access to such Child Software Application first answering certain security or appropriateness questions or agreeing to abide by certain use terms and conditions or both answering certain security or appropriateness questions and agreeing to abide by certain use terms and conditions as specified by the Parent Software Generator User, the System Administrator, or both the Parent Software Generator User and the System Administrator at the time such Child Software Application was created.

16. The computer-implemented method of claim 1, wherein the Parent Software Generator enables a Parent Software Generator User to incorporate electronic data feeds into the Child Software Application at the time of its creation that are either set by the Parent Software Generator User prior to publishing such Child Software Application to an Online Storage Facility or are designated by the one or more party having downloaded such Child Software Application from the Online Storage Facility.

17. The computer-implemented method of claim 1, wherein the system tracks, ranks, and publishes some or all of the characteristics and statistics relating to but not limited to: (a) the number of Child Software Applications so created and published by the particular Parent Software Generator User; (b) the associated Child Software Applications of the particular Parent Software Generator User so downloaded by requesting parties; (c) the various elements memorialized within the Child Software Applications associated with the Parent Software Generator User whether related to the type or size of the financial instruments memorialized; (d) the number of messages from requesting parties a particular Child Software Application generates; (e) the number of messages from requesting parties a particular set of Child Software Applications generates; (f) the number of reply messages generated from the Parent Software Generator User that created a particular Child Software Application; and (g) the number of reply messages generated from the Parent Software Generator User that created a particular set of Child Software Applications.

18. The computer-implemented method of claim 1, wherein the system tracks, ranks, and publishes some or all of the characteristics and statistics relating to but not limited to: (a) the number of Child Software Applications downloaded by a particular party having downloaded such Child Software Applications; (b) the various elements memorialized within the Child Software Applications associated with the downloading activities of a particular party having downloaded such Child Software Applications; (c) the number of messages sent by a particular party having downloaded such Child Software Application in relation to that particular Child Software Application so downloaded; (d) the number of messages sent by a particular party having downloaded a set if Child Software Applications in relation to that particular set of Child Software Applications so downloaded; (e) the number of messages received by a particular party having downloaded such Child Software Application in relation to that particular Child Software Application so downloaded; and (d) the number of messages received by a particular party having downloaded a set of Child Software Applications in relation to the particular set of Child Software Applications so downloaded.

19. The computer-implemented method of claim 1, wherein any one, some, or all of the Parent Software Generator Identification Code, Child Software Application Identification Code, Parent Software Generator User Identification Code, Application Seeking Registrant Identification Code, and Child Software Application Downloading Party Identification Code are stored in a system registry that can be used by the system to track, rank, and publish some or all of the characteristics and statistics relating to activities of any one or more of the parties using the system as well as be used by the system to track, rank, and publish some or all of the characteristics and statistics relating to the content created by, stored within, or disseminated by the system.

20. The computer-implemented method of claim 1, wherein the system enables a Parent Software Generator User to specify the characteristic and statistical information about the Parent Software Generator User that will be shared with one or more parties seeking access to Child Software Applications, with such sharing of information to take place prior to or following such parties' downloading of a Child Software Application authored by the Parent Software Generator User and prior to or following the delivery of messages between the Parent Software Generator User and the party seeking access to the Child Software Application authored by the Parent Software Generator User.

21. The computer-implemented method of claim 1, wherein the system enables any one or more party seeking access to Child Software Applications to specify the characteristic and statistical information about herself that will be shared with a Parent Software Generator User prior to or following the downloading of a Child Software Application by such party seeking access to a Child Software Application and prior to or following the delivery of messages between the Parent Software Generator User and the party seeking access to a Child Software Application.

22. The computer-implemented method of claim 1, where the system has a subscription function to allow a Parent Software Generator User to upload their Child Software Application so created to the Online Storage Facility conditioned upon the payment of a fee to the administrator of the system in consideration of the cost of hosting of the Child Software Application on the system, with such fee being calculated based upon one or more of the characteristics of the unique data set incorporated within the Child Software Application, the characteristics of the hosting service provided by the system, and the characteristics of the commercial relationship as between the administrator of the system and the Parent Software Generator User at the time of such upload of the Child Software Application to the system's Online Storage Facility.

23. The computer-implemented method of claim 1, where the system has a subscription function to allow a Parent Software Generator User to upload their Child Software Application so created to the Online Storage Facility conditioned upon the Parent Software Generator User being compensated by the administrator of the system for creating and uploading such Child Software Application, with such consideration being calculated based upon one or more of the characteristics of the unique data set incorporated within the Child Software Application, the characteristics of the hosting service provided by the system, the characteristics of the commercial relationship as between the administrator of the system and the Parent Software Generator User at the time of such upload of the Child Software Application to the system's Online Storage Facility, and the ability of such Parent Software Generator User to download one or more other Child Software Applications created by other Parent Software Generator Users hosted on the system for free or for a reduced fee.

24. The computer-implemented method of claim 1, where the system has a subscription function to allow one or more party seeking access to a Child Software Application to either search for, access, or search for and accessing a Child Software Application so created and stored within the Online Storage Facility conditioned upon the payment of a fee to the administrator of the system in consideration of the cost of searching for and accessing the Child Software Application on the system, with such fee being calculated based upon one or more of the characteristics of the unique data set incorporated within the Child Software Application, the characteristics of the hosting service provided by the system, and the characteristics of the commercial relationship as between the administrator of the system and the party seeking access to the Child Software Application at the time of such searching for and accessing the Child Software Application from the system's Online Storage Facility.

25. The computer-implemented method of claim 1, where the system has a transaction function that allows one or both of the party who has downloaded a particular Child Software Application and the Parent Software Generator User that authored that particular Child Software Application to make an offer with or without specific commercial terms associated thereto to the other party for purchasing or selling the actual or prospective financial instrument represented by the Child Software Application that is enabling the messaging link between the party who has downloaded that particular Child Software Application and the Parent Software Generator User that authored that particular Child Software Application.

26. The computer-implemented method of claim 1, where the system has a transaction function that allows one or both of the party who has downloaded a particular Child Software Application and the Parent Software Generator User that authored that particular Child Software Application to accept an offer from the other party for purchasing or selling the actual or prospective financial instrument represented by the Child Software Application that is enabling the messaging link between the party who has downloaded that particular Child Software Application and the Parent Software Generator User that authored that particular Child Software Application.

27. The computer-implemented method of claim 1, where the system has a transaction function that allows both of the party who has downloaded a particular Child Software Application and the Parent Software Generator User that authored that particular Child Software Application to fully or partially execute requisite transaction documentation for the purchase and sale of the actual or prospective financial instrument represented by the Child Software Application that is enabling the messaging link between the party who has downloaded that particular Child Software Application and the Parent Software Generator User that authored that particular Child Software Application.

28. The computer-implemented method of claim 1, where the system has a transaction function that allows both of the party who has downloaded a particular Child Software Application and the Parent Software Generator User that authored that particular Child Software Application to fully or partially execute requisite consideration settlement instructions for the purchase and sale of the actual or prospective financial instrument represented by the Child Software Application that is enabling the messaging link between the party who has downloaded that particular Child Software Application and the Parent Software Generator User that authored that particular Child Software Application.

29. A tangible machine readable medium storing instructions that, when executed by a computing device, cause the computing device to perform a method of operating a computer-implemented application creation system comprising:
a. one or more Parent Software Generator capable of creating one or more customizable Child Software Application that serve to memorialize unique data sets pertaining to existing or prospective financial instruments, with such data sets provided to the Parent Software Generator for inclusion within the Child Software Application by the Parent Software Generator User;
b. the ability of such Parent Software Generator to automatically publish such one or more completed Child Software Application to an Online Storage Facility;
c. the ability of such Online Storage Facility to be searched by and results presented to one or more party seeking access to such one or more Child Software Application;
d. the ability of such Online Storage Facility to electronically deliver to such one or more party seeking access to the one or more Child Software Application a copy of such one or more Child Software Application upon request by such one or more party seeking access to such one or more Child Software Application; and
e. the one or more downloaded Child Software Application to be opened, run, and inspected remotely on the computer system of the one or more party seeking access to such one or more Child Software Application.

30. A networked apparatus comprising:
a. a memory;
b. a processor;
c. a communicator;
d. a display; and
e. a suite of software capable of operating a computer-implemented application creation system comprising, one or more Parent Software Generator capable of creating one or more customizable Child Software Application that serve to memorialize unique data sets pertaining to existing or prospective financial instruments, with such data sets provided to the Parent Software Generator for inclusion within the Child Software Application by the Parent Software Generator User; the ability of such Parent Software Generator to automatically publish such one or more completed Child Software Application to an Online Storage Facility; the ability of such Online Storage Facility to be searched by and results presented to one or more party seeking access to such one or more Child Software Application; the ability of such Online Storage Facility to electronically deliver to such one or more party seeking access to the one or more Child Software Application a copy of such one or more Child Software Application upon request by such one or more party seeking access to such one or more Child Software Application; and the one or more downloaded Child Software Application to be opened, run, and inspected remotely on the computer system of the one or more party seeking access to such one or more Child Software Application.
